(19) United States
(12) Patent Application Publication
(10) Pub. No.: US 2008/0292141 A1
(43) Pub. Date: Nov. 27, 2008

(54) METHOD AND SYSTEM FOR TRIGGERING A DEVICE WITH A RANGE FINDER BASED ON AIMING PATTERN

(76) Inventors: Ming Yu, S. Setauket, NY (US); David Tsi Shi, Stony Brook, NY (US)

Correspondence Address: FAY KAPLUN & MARCIN, LLP, 150 BROADWAY, SUITE 702, NEW YORK, NY, 10038, US

(21) Appl. No.: 11/753,693

(22) Filed: May 25, 2007

(51) Int. Cl. G06K 9/00

(52) U.S. Cl. 382/106

(57) ABSTRACT

Described is a method and system for triggering a device with a range finder based on aiming pattern. The system includes a processing device acquiring and processing data; an imager providing an image of an object; a range finder determining a distance from the imager to the object; a timer which is activated by the processing device; and an application acquiring data from the object within a measuring range if the processing device determines that the distance remains within a stabilization range for a period of time.

### FIELD OF INVENTION

The present invention generally relates to a system and method for triggering an application for a hand-operated device.

### BACKGROUND

Mobile devices (e.g., barcode scanners, image-based scanners, RFID readers, radio transceivers, video cameras, etc.) are used in a multitude of situations for both personal and business purposes. These devices often utilize a manually operated mechanical trigger such as a pushable button, a sliding switch, a touch-panel, etc. The trigger requires a user to perform an additional action in order to effect triggering. For example, if the trigger is thumb-activated, the additional action may comprise moving a thumb from a resting position to a triggering position, then manually engaging the triggering mechanism. If the user's hand is occupied with another task, performing the additional action may interrupt or force the user to abandon the task. In some instances, this is merely an inconvenience. However, in situations where the task is mission-critical or time-sensitive, this may be unacceptable. Furthermore, the additional action may be so unnatural that over an extended period of use, the user may experience discomfort or injury. Still other users may be unable to even perform the additional action because of physical defects or disabilities. In demanding industrial environment, the mechanical trigger can be a frequent failure point. Accordingly, a need has developed for an alternative to make mobile devices easier to operate by activating the device without an additional action by the user's finger and with good reliability.

Electronic devices include hand-operated devices which, during use, are positioned on or about a user's hand. The devices are triggered using a finger or thumb of the user. A conventional hand-operated device generally includes a triggering arrangement in the form of a switch which is fixed in size. As a result, the conventional device cannot accommodate different users. For example, differences in finger size may cause the conventional device to be positioned so as to make triggering difficult or uncomfortable. When the switch is too big, user movement may be unnecessarily restricted. When the switch is too small, the user may have difficulty reaching for the switch.

In addition, normal usage may require different operating positions in which a position of the triggering arrangement varies between the different operating positions. Because the size of the trigger arrangement is fixed, triggering may be comfortable in one position and difficult or uncomfortable in a second position. Thus, user characteristics and/or changing operating conditions may affect the user's comfort or ability to operate the conventional device.

### SUMMARY OF THE INVENTION

The present invention relates to a method and system for triggering a device with a range finder based on aiming pattern. The system includes a processing device acquiring and processing data; an imager providing an image of an object; a range finder determining a distance from the imager to the object; a timer which is activated by the processing device; and an application acquiring data from the object within a measuring range if the processing device determines that the distance remains within a stabilization range for a period of time.

### BRIEF DESCRIPTION OF THE DRAWINGS

FIG. 1 shows an exemplary system for automatically activating an application and/or component of a handheld mobile unit according to the present invention.

FIG. 2A represents an exemplary method for activating specific applications for hand-operated devices according to the exemplary embodiments of the present invention.

FIG. 2B represents further steps of the method in order to account for the contrast of the images provided by the imager according to the exemplary embodiments of the present invention.

### DETAILED DESCRIPTION

The present invention may be further understood with reference to the following description of exemplary embodiments and the related appended drawings, wherein like elements are provided with the same reference numerals. The present invention is related to a system and method for activating (e.g., triggering) a specific functionality for a handheld device without requiring a mechanical activation by a user's finger. Specifically, the present invention is related to a system and method for automatically triggering a data collecting application based on constantly monitoring the range data to any object that is being aimed at, intentionally or otherwise. The range data is deduced from the image of an aiming pattern for a mobile unit (“MU”). The exemplary system and method described herein may serve as an alternative triggering method to the traditional methods used by mechanical triggers on the MU.

Various embodiments of the present invention will be described with reference to a wearable barcode scanner, such as, for example, a ring scanner. However, those skilled in the art will understand that the present invention may be implemented with any electrical and/or mechanical hand-operated device that is capable of being triggered and where the triggering may activate any functionality of the device.

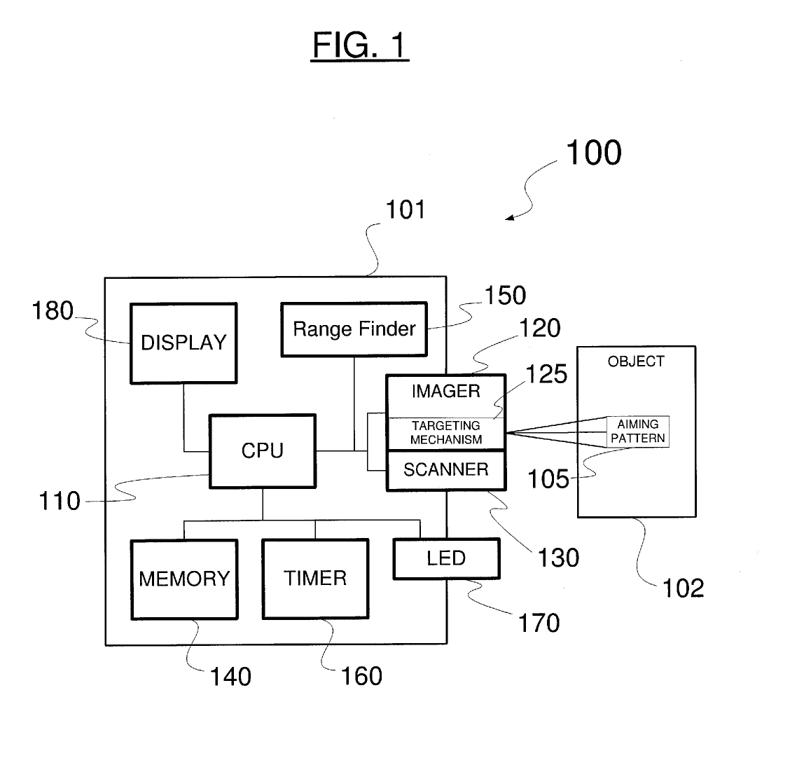

FIG. 1 shows an exemplary system 100 for automatically activating an application and/or component of a handheld MU 101, such as activating a barcode scanning component on the MU 101. According to the exemplary embodiment, FIG. 1 shows a block diagram view of the handheld MU 101 (e.g., the barcode scanner) according to the present invention. The scanner 101 may be a ring scanner worn on a finger (e.g., an index finger) of the user. The MU 101 may include a “function module” or a central processing unit (“CPU”) 110, an imaging component (e.g., imager 120), an automatic identification (“auto-ID”) input component (e.g., an optical barcode scanner 130), a memory 140, a range finder mechanism 150, a timer 160, an illumination element 170, and a display screen 180. The scanner 130 may be communicatively coupled to a further device such as, for example, a data acquisition terminal of the MU 101. The MU 101 may incorporate a variety of auto-ID input methods. Specifically, exemplary management features available to the MU 101 may include, but are not limited to, barcode scanning, imaging (i.e., photo capturing), radio frequency identification (“RFID”) tracking, location awareness (i.e., real-time location systems (“RTLS”)), global positioning system (“GPS”) devices, motion and/or touch-sensitive gloves, and peer-to-peer communications (i.e., ad-hoc communications).

It is important to note that the CPU 110 may include one or more electrical and/or mechanical components for executing a function of the exemplary MU 101. For example, if the auto-id input component of the MU 101 is an RFID reader, then function module 110 may include an RF transmitting and receiving arrangement for reading RF tags. The function module 110 may also include software components for controlling operation of the electrical/hardware components.

The CPU 110 may regulate the operation of the MU 101 by facilitating communications between the various components of the MU 101. For example, the CPU 110 may include a processor, such as a microprocessor, an embedded controller, an application-specific integrated circuit, a programmable logic array, etc. The CPU 110 may perform data processing, execute instructions and direct a flow of data between devices coupled to the CPU 110 (e.g., the imager 120, the memory 140, the display 180, etc.). As explained below, the CPU 110 may receive an input from the imager 120 and in response, may instruct the MU 101 to activate auto-id input component, such as the barcode scanner 130.

The memory 140 may be any storage medium capable of being read from and/or written to by the CPU 110, or another processing device. The memory 130 may include any combination of volatile and/or nonvolatile memory (e.g., RAM, ROM, EPROM, Flash, etc.). The memory 140 may also include one or more storage disks such as a hard drive. Accordingly to one embodiment of the present invention, the memory 140 may be a temporary memory in which data may be temporarily stored until it is transferred to a permanent storage location (e.g., uploaded to a personal computer). In another embodiment, the memory 140 may be a permanent memory comprising an updateable database.

The imager 120 may include any combination of hardware and/or software for continuously monitoring a distance range of the MU 101 to an object 102. Specifically, the imager 120 may use proximity sensing technology, such as spatial parallax range detection. The imager 125 may include a targeting mechanism 125 capable of projecting an aiming pattern 105 onto the object 102. For example, the targeting mechanism 125 may emit a laser from within the imager 120 towards the object 102. Thus, the laser may produce a visible pattern (e.g., the aiming pattern 105) on the object 102 in order to indicate the point of view for the imager 120. According to an exemplary embodiment of the present invention, the imager 120 may determine a distance from the imager 120 to the object 102 through the use of spatial parallax range detection. Specifically, the imager 120 may determine the center position of the aiming pattern 105 projected onto the object 102 as viewed on the image taken by the imager. For example, the aiming pattern 105 projected onto an object close to the imager 120 will have a different position then when the aiming pattern is projected onto an object that is further from the imager 120 (e.g., the aiming pattern projected onto a close object will appear more de-centered on the picture than when it is projected onto a further object). The imager 120 may repeatedly capture images of the aiming pattern 105 as it is projected onto various objects, such as object 102, a box, a wall, etc. Accordingly, spatial parallax may be used to translate the variations in the image position of the projected aiming pattern 105 on the various objects into measurements of distance from the imager 120 to each of the objects.

Spatial parallax may be described as a distance between a stereo pair of images taken of the same object from the at least two different viewing perspectives of the imager 120. Spatial parallax may define an apparent shift in the position of the object in a field of view due to the relative change in position of that object and the location from which the object is viewed. Accordingly, the imager 120 of the exemplary embodiment of the MU 101 may determine a distance range by reading a distance-measuring portion that is offset from center. The offset of the distance-measuring portion may be due to a parallax effect. As will described in greater detail below, this offset may be converted using known techniques into a distance from the MU 101 to the object 102 after calibration.

In order to calculate the measurements of distances, the imager 120 may be in communication with the range finder mechanism 150. Specifically, the range finder mechanism 150 then process the monitored distances and calculate the distance between the MU 101 and the various objects (e.g., object 102, the wall, etc.). The processed data from the range finder mechanism 150 may be transmitted to the CPU 110 for further processing. It is important to note that while the range finder mechanism 150, as illustrated in FIG. 1, appears as a separate component from the imager 120, alternative embodiments of the present invention may incorporate the functions and processes of the range finder mechanism 150 into the imager 120, effectively combining the separate components into a single component. In addition, the range finder mechanism 150 may also be located within the CPU 110, thereby allowing the CPU 110 to perform the functions and processes of the range finder mechanism 150.

According to one embodiment of the present invention, the imager 120 may also determine a relative contrast of an image or pattern. Specifically, the imager 120 may determine a contrast measurement, of a mark within the image, such as, the aiming pattern 105 in relationship to the surrounding environment. The contrast measurement system utilized by the imager 120 may be a grey level ratio between the aiming pattern and its surrounding as viewed on the image. These contrast measurements may be taken by the imager 120 in succession and then used to calculate the relative contrast of the image. Thus, after calibration, the imager 120 may use the contrast measurements to determine whether additional illumination is required in order to make an accurate reading of the mark (i.e., the barcode symbol). In other words, the imager 120 may use the contrast measurements to determine the brightness of the aiming pattern 105 relative to the surrounding environment. If the surrounding environment is of a similar brightness (e.g., nearly as bright) to the aiming pattern 105, i.e., low contrast, then it may be presumed that the surrounding environment is of an adequate brightness and no additional illumination is needed for the imager 120. However, if the surrounding environment is of a lot lesser brightness (e.g., dark) than the aiming pattern 105, i.e., high contrast, then it may be presumed that additional illumination is required for the imager 120 to take a clear image of the object 102.

According to an exemplary embodiment of the present invention, the additional illumination may be provided by a lighting element, such as a light emitting diode (“LED”) 170. Accordingly, the imager 120 may activate the LED 170 when the contrast measurement is too high indicating inadequate illumination for an accurate reading and the imager 120 may deactivate the LED 170 when additional illumination is not needed. Thus, the activation and deactivation of the LED 170 by the imager 120 may serve as an energy saving measure to preserve the battery life of a power source within the MU 101. The use of the LED 170 will be described in further detail below.

Although images need to be taken for both range finding and contrast measurement, theses can be low resolution and/or even partial images and/or at low frame rate to save processing power and increase processing speed.

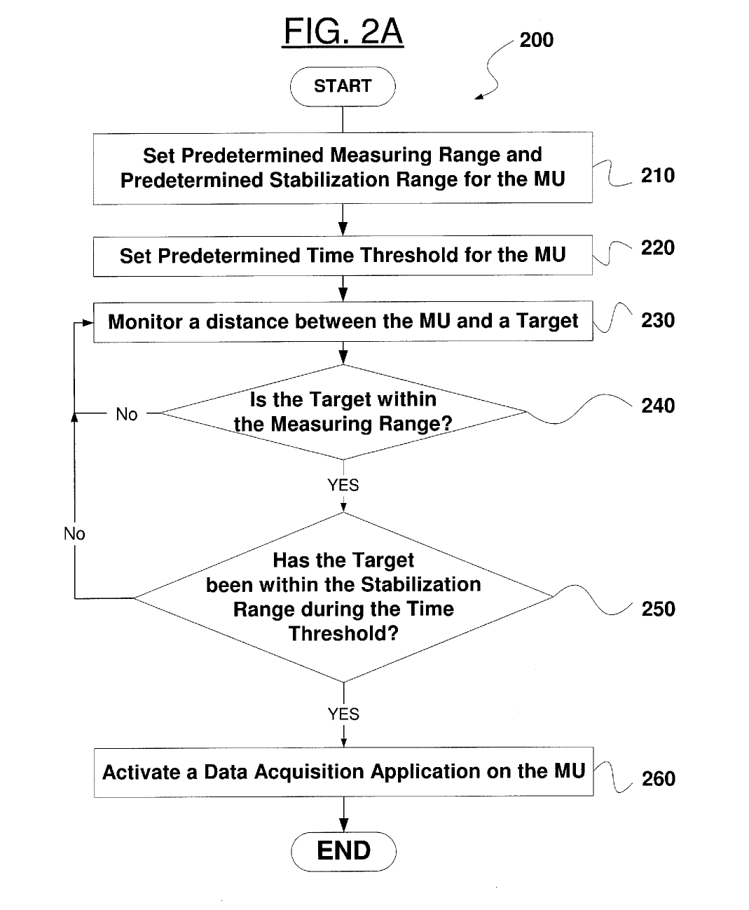

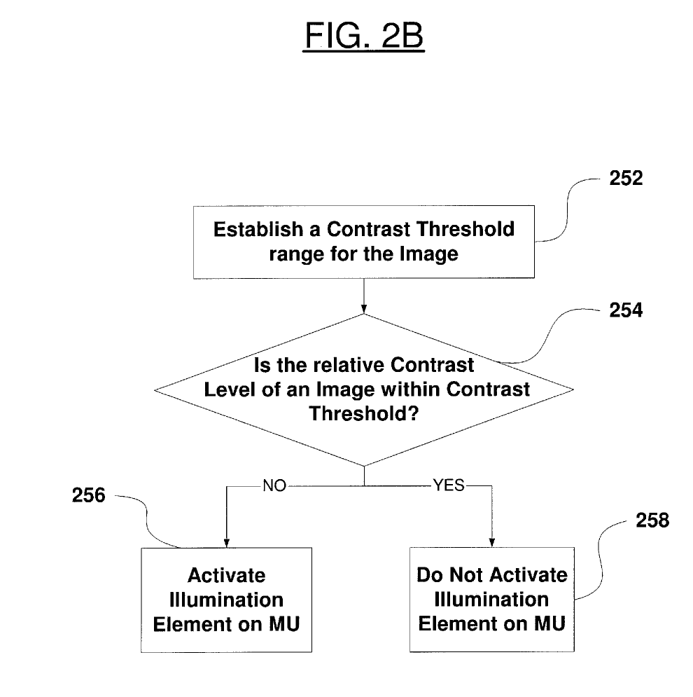

FIG. 2A represents an exemplary method 200 for activating specific applications for hand-operated devices according to the exemplary embodiments of the present invention. The exemplary method 200 will be described with reference to the exemplary system 100 of FIG. 1. As described above, the exemplary MU 101 may be a device such as a user-worn ring barcode scanner. In order to activate an application, such as triggering the data capturing function of the barcode scanner, the MU 101 determine whether the object 102 is within a readable distance and whether the MU 101 has remained “stable” for period of time. The readable distance may be defined as stable if the distance variation between the MU 101 and the object 102 is within a set range, such as a stabilization range. Specifically, the range finder mechanism 150 may calculate the distance of the MU 101 to the object 102, such as an object having barcode, through the use of images of the object 102 provided by the imager 120.

In step 210, a predetermined measuring range may be set for the MU 101. The predetermined measuring range may relate to a preferable span of distances from the object 102 (e.g., scanning range) in which the data acquisition device (e.g., the barcode scanner 130) may make an accurate reading of the object 102. Accordingly, any measured distance within the predetermined measuring range may allow for optimal performance of the data acquisition device. For example, an exemplary predetermined measuring range may be 4 to 10 inches from the imager 120. The distance data processed by the range finder mechanism 150 may be compared to this measuring range in order to determine when the object 102 is within a readable distance from the MU 101. Accordingly, when the object 102 is outside of the predetermined measuring range (i.e., at a closer distance than 4 inches or at a further distance than 10 inches), the data acquisition device may be unable to read the object 102. The span of the predetermined measuring range may be based on the specific functions of the MU 101 and/or the data acquisition device of the MU 101. Thus, the range may vary from one device to the next, as well as vary according to the operations of each device. The predetermined measuring range may be stored in the memory 140 of the MU 101.

Furthermore, in step 210, a predetermined stabilization range may also be set for the MU 101. The predetermined stabilization range may relate to a preferable span of distances from the object 102 in which it may be presumed that the user of the imager 120 intends to activate the data acquisition device (e.g., scanner 130). Specifically, once the object 102 is within the predetermined measuring range, the setting of the stabilization range may prevent the MU 101 from activate a false trigger on the data acquisition device during a predetermined period of time. For example, an exemplary predetermined stabilization range may be set to a range such as 2 inches (e.g., ±1 inch from an initial reading distance) from the imager 120. Thus, if the object 102 is held within the plus/minus one-inch range from the imager 120 for a period of time, the imager 120 may be defined as being held “stable” in relationship the object 102.

In step 220, the method 200 may set the predetermined time threshold for the MU 101. Specifically, the timer 160 within the MU 101 may be calibrated to track a specific interval of the predetermined time threshold. The predetermined time threshold may correlate to a period of time in which a user maintains the distance between the MU 101 and the object 102 within the predetermined measuring range. In other words, the time threshold may measure the length of time in which the distance between the MU 101 and the object 102 remains within the predetermined measuring range set in step 210. While the object 102 is within the measure range, and subsequently held stable within the stabilization range, it may be presumed that the object 102 is an intended object (i.e., a barcode) and the MU 101 may wish to activate a data acquisition application (e.g., triggering the barcode scanner 130) for the intended object. However, if the object 102 fails to remain at a distance from the MU 101 within the stabilization range during the duration of the time threshold, it may be presumed that the object 102 is not an intended object, such as a wall, and the MU 101 may not activate the data acquisition application. The time threshold may be set to an optimal time period based on the preferred usage of the MU 101 in order to activate the data acquisition device (e.g., barcode scanner 130). Accordingly, the optimal time period may allow for unintentional objects to be ignored while the intended objects may be noticed. It is important to note that while the timer 160, as illustrated in FIG. 1, appears as a separate component from the CPU 110, alternative embodiments of the present invention may incorporate the functions and processes of the timer 160 into the CPU 110, effectively combining the separate components into a single component. The predetermined time threshold may be stored in the memory 140 of the MU 101.

In step 230, the MU 101 may monitor a distance between the MU 101 and the surrounding environment of the MU 101, wherein the distance may be defined as an object landed on by the center of aiming pattern. Each object (e.g., object 102, a wall, a box, etc.) of the surrounding environment that comes within the field of the imager 120 may be a potential object. Thus, in order to allow the MU 101 to ignore unintentional objects while noticing intended objects, the imager 120 may be taking constant measurement readings of each object that it comes across. As described above, the range finder mechanism 150 may utilize a proximity sensing technology (e.g., spatial parallax range detection) in order to continuously monitor the distances to the respective potential objects. Specifically, the range finder mechanism 150 may receive images of the object 102 from the imager 120 and determine the offset from center for the object 102 due to the parallax effect. Accordingly, the spatial parallax range detection may allow the range finder mechanism 150 to process the images provided by the imager 120 and then convert parallax readings of the object 102 into measurement distances between the MU 101 and the object 102. Therefore, when the object 102 comes within view of the imager 120, the object 102 may be considered to be a potential object of interest and the method may advance to step 240.

In step 240, a determination may be made as to whether the measured distance between the MU 101 and the object 102 is within the predetermined measuring range. According to the exemplary embodiment of the present invention, this measured distance may be made by the range finder mechanism 150. The CPU 110 may perform the comparison process of the measured distance to the object 102 and the measuring range. Due to the fact that the imager 120 may be continuously monitoring the surrounding environments, the predetermined measuring range allows the range finder 150 (or CPU 110) to ignore all objects that are at a distance from the MU 101 that is outside of the measuring range. When the object 102 is determined to be within the measuring range, the method 200 may advance to step 250. However, while the object 102 remains outside of the measuring range, the method 200 may return to step 230 for continued monitoring.

Using the example provided in step 210, the measuring range (e.g., scanning range) may be set to an exemplary range of 4 to 10 inches from the MU 101. Any objects within the view of the imager 120 that are not within 4 to 10 inches from the MU 101 may be ignored and the imager 120 may continue to monitor the surrounding environment. Once one object, such as the object 102, is determined to be within the 4 to 10 inches, the CPU 110 may take notice of the object 102 and the method 200 may advance to step 250.

In step 250, a determination may be made as to whether the distance between the MU 101 and the object 102 has remained “stable” within the predetermined time threshold. As described above, the distance may be considered stable if the object 102 remains at a distance to the MU 101 that is within the predetermined stabilization range. During the period in which the distance between the object 102 and the MU 101 is held stable, the CPU 110 may monitor the timer 160. Once the timer 160 has reached the predetermined time threshold, the object 102 may be determined to be an intended object and the method may advance to step 260. If the object 102 fails to remain at a distance within the predetermined stabilization range prior to the timer 160 reaching the predetermined time threshold, it may be presumed that the object 102 is an unintended object and the method may return to step 230 for continued monitoring of the surrounding environment.

For example, an exemplary time threshold may be set to 20 milliseconds. Furthermore, in reference to the example, a distance may remain stable if the object 102 within the measuring range (4-10 inches) from the MU 101 remains stable (±1 inch from an initial reading distance) during the 20-millisecond threshold. In other words, the timer 160 may be activated once the object 102 is within a distance between 4 to 10 inches from the MU 101. The timer 160 may be monitored upon activation while the object 102 remains within the stabilization range of plus/minus one-inch. Once the timer 160 measures that the object 102 has remained within the stabilization range (e.g., ±1 inch from an initial reading distance) for 20 milliseconds, the object 102 may be considered to be an intended object of interest and the method 200 continues to step 260. However, if the object 102 moves outside of the stabilization range (e.g., over an inch closer or further from the MU 101 from the initial measurement distance) before the span of 20 milliseconds, the object 102 may not be considered to be an intended object of interest and the method continues monitoring at step 230.

In step 260, the data acquisition application may be activated (e.g., the scanner function of the barcode scanner may be triggered) when the object 102 is within the predetermined measuring range and the distance between the object 102 and the MU 101 has remained stable during the predetermined time threshold. In other words, if the object 102 has been determined to be within the measuring range, and the object 102 has remained within the stabilization range for the duration of the time threshold, the MU 101 may activate the data acquisition application. Thus, according to the above-referenced examples wherein the measuring range is 4 to 10 inches and the time threshold is 20 milliseconds, the object 102 was within a distance between 4 to 10 inches (and remained within that range of a stable distance that is no more than ±1 inch from the first detected distance within the larger range) from the MU 101 for 20 milliseconds, the CPU 110 may presume that object 102 is an intended object of interest and the data acquisition application may be activated.

According to an additional and/or alternative embodiment of the present invention, the method 200 may further include determining a relative contrast of an image of the object 102 as provided by the imager 120. Specifically, the method 200 may determine that an illumination element (e.g., LED 170) should be activated, wherein the activation of the illumination element (e.g., LED 170) allows for improved operations of the data acquisition functions of the MU 101. Furthermore, the method 200 may decide to only activate the illumination element when additional light is needed. Thus, the method 200 may reduce power consumption (e.g., preserve battery life), as well as preserve the illumination element itself (e.g., a bulb), by only activating the illumination element when needed.

Accordingly, as illustrated in FIG. 2B the method 200 may further include steps 252, 254, 256, and 258 in order to account for the contrast of the images provided by the imager 120. It is important to note that while these additional steps numerically follow step 250 and are performed prior to the activation step 260, the additional steps may be performed in method 200 at anytime prior to the activation of the data acquisition device in step 260.

In step 252, the method 200 may establish a contrast threshold range for the imager 120. Adjustments to the contrast threshold range may allow for optimal performance of the data acquisition device. Specifically, any images provided by the imager 120 that have a contrast outside of the contrast threshold range may activate the illumination element, such as LED 170. Accordingly, the activation of the LED 170 may allow for a reduction in the relative contrast of the image, thereby providing an optimal contrast setting for reading and processing the image. Similar to the measuring range and the time threshold, the contrast threshold may be based on the specific functions of the MU 101 and/or the data acquisition device of the MU 101. Thus, the range may vary from one device to the next, as well as vary according to the operations of each device. Furthermore, the contrast threshold range may be stored in the memory 140 of the MU 101.

In step 254 a determination may be made as to whether a relative contrast level of the image provided by the imager 120 is within the contrast threshold range. Specifically, the imager 120 may compare the contrast of a mark on the image, such as the aiming pattern 105, to the contrast of the surrounding environment of the image. According to an exemplary embodiment of the present invention, the aiming pattern 105 may be a laser projection from the targeting mechanism 125 of the imager 120. The laser projection of the aiming pattern may have a known contrast level used for the comparison to the contrast levels within the image.

The CPU 110 and/or the imager 120 may process the image in order to perform this comparison. When the relative contrast exceeds the threshold, the method 200 may advance to step 256. However, if the image is within the contrast threshold, the image may be readable by the barcode scanner. Accordingly, the method 200 may advance to step 258.

In step 256 the illumination element (e.g., LED 170) may be activated when the relative contrast of the image is higher than the contrast threshold range. Thus, the relative contrast of the image may be used to decide whether the illumination element (e.g., LED 170) should be turned on. In other words, when the relative contrast of the image is high, the illumination element (e.g., LED 170) may be beneficial. Alternatively, when the relative contrast is normal or low, the activation of the illumination element (e.g., LED 170) would be unnecessary.

In step 258 the illumination element may not be activated when the relative contrast of the image is higher than the contrast threshold range. Thus, by allow the illumination element to be activated only when needed, the MU 101 may conserve power consumption.

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
monitoring a distance between a device and an object based on a detected aiming pattern projected onto the object;
determining whether the distance is within a measuring range;
determining whether the object within the measuring range remains within a stabilization range for a period of time; and
activating an application of the device when the distance remains within the stabilization range.

2. The method according to claim 1, further comprising:
setting the measuring range based on a performance of the device setting the stabilization range based on a performance of the device; and
setting the period of time based on the performance of the device.

3. The method according to claim 1, further comprising:
providing an image of the aiming pattern on an object;
determining from the image a contrast of the aiming pattern relative to a surrounding area from the image; and
activating an illumination element when the contrast of the image is outside of a contrast threshold.

4. The method according to claim 3, further comprising:
setting a contrast threshold as a function of a performance of the device.

5. The method according to claim 1, wherein the application is a data acquisition application.

6. The method according to claim 1, wherein the device includes at least one of a barcode scanner, an image-based scanner, a laser-based scanner, an RFID reader, a GPS handheld, a motion sensitive glove and a touch-sensitive glove.

7. The method according to claim 1, wherein the object is a barcode, and the application involves scanning a barcode.

8. The method according to claim 1, wherein the monitoring is performed using spatial parallax range detection of a projected aiming pattern.

9. The method according to claim 3, wherein the illumination element is a light emitting diode (“LED”).

10. A system, comprising:
a processing device acquiring and processing data;
an imager providing an image of an object;
a range finder determining a distance from the imager to the object;
a timer which is activated by the processing device; and
an application acquiring data from the object within a measuring range if the processing device determines that the distance remains within a stabilization range for a period of time.

11. The system according to claim 10, further comprising:
an illumination element.

12. The system according to claim 11, wherein the illumination element is activated when the contrast of the image is outside of a contrast threshold.

13. The system according to claim 10, wherein the system is operable on one of a barcode scanner, an image-based scanner, a laser-based scanner, an RFID reader, a GPS handheld, a motion sensitive glove and a touch-sensitive glove.

14. The system according to claim 10, wherein the object is a barcode, and the application is scanning a barcode.

15. The system according to claim 10, wherein the monitoring is performed using spatial parallax range detection based on a projected aiming pattern.

16. The system according to claim 11, wherein the illumination element is a light emitting diode (“LED”).

17. A device, comprising:
monitoring means for monitoring a distance between a device and an object for a period of time based on a detected aiming pattern projected onto the object;
range determining means for determining whether the distance is within a measuring range;
time determining means for determining whether the distance of the object within the measuring range remains within a stabilization range for the period of time; and
application activating means for activating an application on the device when the distance is within the measuring range and when the distance remains within the stabilization range for the period of time.

18. The device according to claim 17, further comprising:
range setting means for setting the measuring range based on a performance of the device and for setting the stabilization range based on the performance of the device; and
time setting means for setting the period of time based on the performance of the device.

19. The device according to claim 18, further comprising:
imaging means for providing an image of the object;
contrast determining means for determining a contrast of the image; and
illumination activating means for activating an illumination element when the contrast of the image is not within a contrast threshold.
